(19) United States
(12) Patent Application Publication
(10) Pub. No.: US 2015/0356274 A1
(43) Pub. Date: Dec. 10, 2015

(54) METHODS AND SYSTEMS TO CREATE AND APPLY MODELS THAT SCREEN PATIENTS FOR REFERRAL TO A SPECIALIST FOR A MEDICAL THERAPY

(71) Applicant: Medtronic, Inc., Minneapolis, MN (US)

(72) Inventors: Shuxing Mark Sun, Maple Grove, MN (US); Helen B. Berrier, White Bear Lake, MN (US); Glenna L. Case, Minneapolis, MN (US); Roland Marion-Gallois, Morges VD (CH); Kristin A. Schwartz, Minneapolis, MN (US); Carine Van den Abeele, Vaud (CH); Stephen D. Boeh, Woodbury, MN (US); Steven Broste, Champlin, MN (US)

(73) Assignee: Medtronic, Inc., Minneapolis, MN (US)

(21) Appl. No.: 14/295,621

(22) Filed: Jun. 4, 2014

(51) Int. Cl. G06F 19/00; G06Q 30/02; G06F 17/30

(52) U.S. Cl. CPC G06F 19/363; G06F 17/30864; G06Q 30/0205; G06F 19/322

(57) ABSTRACT

A screening tool for deciding whether to refer patients to a specialist who provides a particular medical therapy is created as a model that is trained, validated, and then applied to subject patients. The training of the model utilizes a training set of answers to the set of questions and a specialist conclusion about referral for the patients who provided the training set of answers in order to drive the model to an ideal sensitivity and an ideal specificity. The model is then validated using a validation set of answers and a specialist conclusion about referral for the patients who provided the validation set of answers to produce a resulting sensitivity and specificity. Once the resulting sensitivity and specificity achieve a target, the model is validated and is then used in practice for subject patients.

### TECHNICAL FIELD

Embodiments relate to screening models. More particularly, embodiments relate to the creation and application of models that screen patients to find candidates to be referred for further assessment by a specialist for a particular medical therapy.

### BACKGROUND

Patients with a particular medical condition typically visit a primary care physician as a first effort to seek treatment. This is particularly true for patients whose medical insurance requires referrals to specialists prior to covering visits to the specialists. For medical conditions that may require involvement by a specialist, the primary care physician must make a judgment call regarding whether the patient should visit the specialist for further assessment. Due to the specialty medical knowledge or clinical practice that primary care physicians may not have acquired in general, inevitably, some patients that would benefit from an assessment by a specialist may not be referred while patients that ultimately do not require an assessment by a specialist are referred. This scenario creates inefficiencies by requiring specialists to exclude patients from further assessment who could have been excluded by the primary care physician. This scenario can also result in patients experiencing medical care that may be less adequate than might otherwise be the case because they are never referred when they could benefit from the advanced specialty therapy but are never assessed.

For medical conditions that may benefit from an adjunctive therapy of advanced specialty treatment, such as an active implantable medical device that provides electrical stimulation therapy, this issue may be even more pronounced. Primary care physicians are often unfamiliar with these advanced methods of treatment and may not recognize when patients are potential candidates for such treatment methods and therefore fail to refer patients to the appropriate specialist. As a result, the patient is never given the opportunity to experience the stimulation therapy in a trialing period to assess whether the electrical stimulation would be an effective solution for the long term.

### SUMMARY

Embodiments address issues such as these and others by providing methods and systems for creating a screening tool in the form of a model that may be applied by a primary care physician or other medical professional who may need to refer patients to specialists for further assessment. The model receives answers a patient provides to a series of questions as the input and then generates a conclusion regarding whether the patient should be referred for further assessment by a specialist. The model is created by starting with an initial model that is then trained with a given set of patient inputs and specialist conclusions for those patients by driving the model to an ideal specificity and sensitivity. The model is then validated against a target specificity and a target sensitivity by application to another set of patient inputs and comparing the results to specialist conclusions for those patients to ensure that the model meets the target specificity and target sensitivity.

Embodiments provide a method of creating a screening tool related to a medical therapy. The method involves training a model that predicts whether a patient is a candidate for assessment by a specialist for the medical therapy based at least on answers patients provide to a set of questions, the model being trained by driving the model to an ideal sensitivity and ideal specificity. The model is driven to the ideal sensitivity and ideal specificity by using patient answers to the set of questions from a first set of patients and using a conclusion by at least one specialist of whether each patient of the first set is a candidate. The method further involves validating the model in relation to a target sensitivity and target specificity that is less than the ideal sensitivity and ideal specificity. The model is validated by applying the model to at least patient answers to the set of questions from a second set of patients to produce a result for each patient of the second set. The result for each patient of the second set is compared to a conclusion by at least one specialist of whether each patient of the second set is a candidate to produce a resulting sensitivity and a resulting specificity, and the resulting sensitivity is compared to the target sensitivity and the resulting specificity is compared to the target specificity.

Embodiments provide a method of applying the model after the model has been trained and validated. Prior to a subject patient being assessed by a subject specialist, the method involves obtaining answers to the set of questions from the subject patient and applying the model to at least the answers from the subject patient. The method further involves referring the subject patient to the subject specialist when a result of applying the model predicts that that subject patient is a candidate for assessment, and not referring the subject patient to the subject specialist when the result of applying the model predicts that that subject patient is not a candidate for assessment.

Embodiments provide a computer system for creating a screening tool related to a medical therapy. The computer system includes a processor that is configured to train a model that predicts whether a patient is a candidate for assessment by a specialist for the medical therapy based at least on answers patients provide to a set of questions. The model is trained by driving the model to an ideal sensitivity and ideal specificity by using patient answers to the set of questions from a first set of patients and using a conclusion by at least one specialist of whether each patient of the first set is a candidate. The processor is further configured to validate the model in relation to a target sensitivity and target specificity that is less than the ideal sensitivity and ideal specificity. The model is validated by applying the model to at least patient answers to the set of questions from a second set of patients to produce a result for each patient of the second set and comparing the result for each patient of the second set to a conclusion by at least one specialist of whether each patient of the second set is a candidate to produce a resulting sensitivity and a resulting specificity. The model is further validated by comparing the resulting sensitivity to the target sensitivity and the resulting specificity to the target specificity.

### DESCRIPTION OF THE DRAWINGS

FIG. 1 shows an example of a process for creating a model to use as a screening tool for referring a patient with a medical condition to a specialist.

FIG. 2 shows an example of a computer system for creating and applying the model.

FIG. 3 shows an example of a model that has been built using a neural network.

### DETAILED DESCRIPTION

Embodiments provide methods and systems to create and apply a model as a screening tool for medical professionals to use when determining whether to refer a patient to a specialist for further assessment. The screening tool allows the medical professional to determine whether to refer the patient to the specialist for further assessment regardless of the degree of knowledge the medical professional may have regarding advanced therapies that the specialist may offer to benefit the patient.

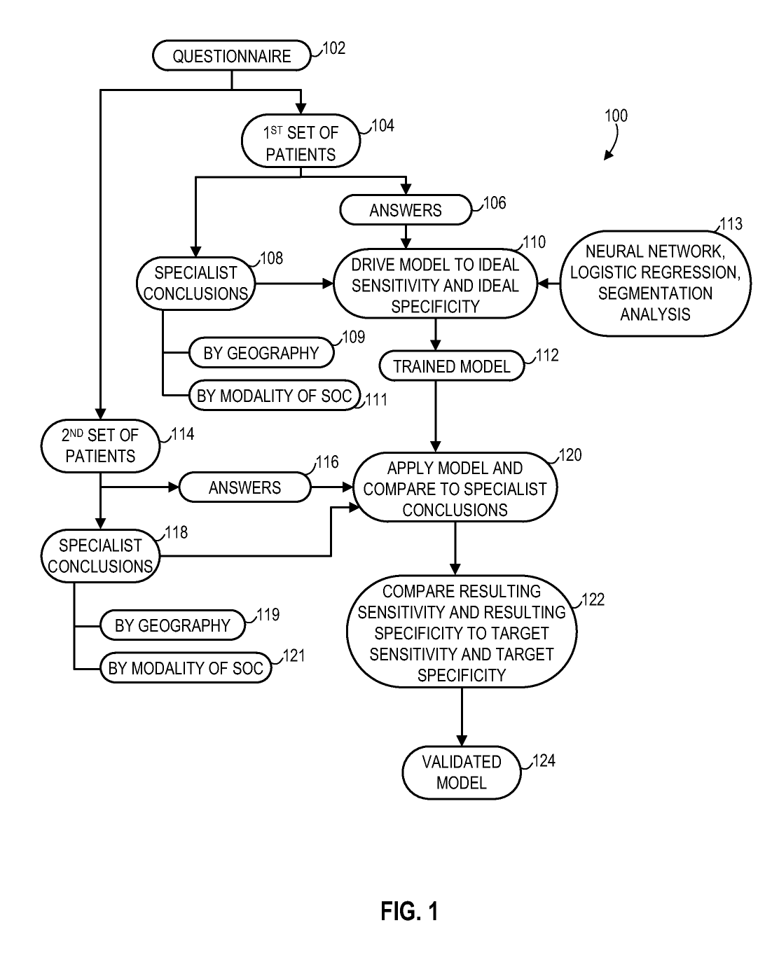

FIG. 1 shows a process 100 for creating and validating the screening tool model. A set of sample data is created by providing a questionnaire 102 to a first sample set of patients 104. The set of questions of the questionnaire 102 may be created by one or more specialists who have an understanding of the types of information that are relevant to the determination of whether the patient could be a candidate for a particular therapy. An example of the questionnaire 102 is included in Appendix S2 of Baron et al, Refractory Chronic Pain Screening Tool (RCPST): A Feasibility Study to Assess Practicality and Validity of Identifying Potential Neurostimulation Candidates, Pain Medicine 2014; 15: 281-291, Wiley Periodicals, Inc. The Appendix S2 is incorporated herein by reference. As can be seen, in this example of the Appendix S2, the questionnaire includes aspects of patient self assessment, beside sensory tests performed on the patient by the referring physician to elicit various patient answers, and neuropathic pain assessments performed by the referring physician to elicit various patient answers.

The patients 104 provide answers 106 to the questions. The patients 104 may be selected from a random group of individuals known to have a particular ailment that is related to an advanced therapy that may be offered by specialists. Among this first set of patients 104, there is a spectrum of patients ranging from those who are considered strongly by specialists to be candidates for further assessment to patients who are considered strongly by specialists to not be candidates for further assessment.

A specialist examines each patient of the set 104 to reach a conclusion 108 for each patient as to whether the patient should be referred for further assessment. The answers 106 of each patient and the conclusions 108 for each patient are input into a statistical modeling technique 113 such as a neural network, a logistic regress, and/or a segmentation analysis to create the mathematical model. The model is trained by the operation 110 of driving the model to an ideal sensitivity and an ideal specificity, for instance both an 100% sensitivity and an 100% specificity by forcing the model to match the relationship of the answer data 106 and the conclusion data 108 in a neural network. The sensitivity indicates how often the model correctly predicts that a patient should be referred and thus the ideal aims to eliminate false non-referrals. The specificity indicates how often the model correctly predicts that a patient should not be referred and thus the ideal aims to eliminate false referrals.

The result of the operation 110 is a trained model 112 which can then be validated. The validation is performed by applying the trained model 112 to answers 116 of a second set of patients 114 to the same questionnaire 102 to produce a prediction for each of the patients 114. This prediction for each of the patients 114 is then compared to a conclusion 118 for each of the patients 114 by a specialist regarding whether the patient should be referred at an operation 120. The comparison of the predictions by the model 112 to the conclusions 118 of the specialists produces a resulting sensitivity and specificity that is then compared to a target sensitivity and a target specificity chosen for the model 112 to ensure that the model 112 is as accurate as desired at an operation 122. If the target specificity and/or sensitivity is not reached by the model 112, then the prior efforts may be repeated with a different or larger set of patients to produce another trained model 112 which can be further validated. Once the target specificity and sensitivity have been reached statistically, then the model is considered a validated model 124 that can be applied in practice. The target specificity and sensitivity values chosen may vary from one context to another, but one example would be a target sensitivity of 80% and a target specificity of 70% to be reached at a 90% statistical power.

The validated model 124 can be created as a generally applicable model or alternatively a more specialized model can be created based on the criteria used for the specialists providing the conclusions 108 for training and the conclusions 118 for validation. For example, rather than having a model that is presumed to apply equally well across all geographical locations, the trained model 112 may be constructed for a particular geographical area and may be validated for that particular geographical area by utilizing specialists who practice within the specific geographical area 109 of interest and therefore apply judgments and expertise that may be unique to that area 109. A separate trained model 112 may be constructed for use in a different geographical area by utilizing specialists who practice within the different geographical area and therefore have judgment and expertise unique to that different area. For instance, certain types of therapies may not be approved for use in certain jurisdictions and this may drastically alter the conclusions 108, 118 of a specialist from that jurisdiction relative to the conclusions 108, 118 of a specialist from another jurisdiction where the certain type of therapy is approved for use.

In such a case, it may further be beneficial to have the training set of patients 104 and the validation set of patients 114 be chosen based on their geographical location as well. Therefore, the specialist from a given geographical location is providing a conclusion about whether patients should be referred where those patients are from the same geographical area as the specialist.

As another example of how the model can be customized, the modalities of standard of care 111 for the specialists may vary from one specialist to the next and may even change over time for a given specialist. Therefore, the model 112 may be trained on the basis of a particular specialist and those primary care physicians who refer patients to that particular specialist may employ the model that has been trained for that particular specialist.

Additionally, the process 100 for creating the trained and validated model 124 may be applied in multiple contexts for specialist referrals. The questionnaire 102, the sample sets for the patients, and the specialists used to provide the conclusions may be changed to correspond to the relevant medical context. With these aspects established, the process 100 may then be repeated for any number of medical contexts. For example, this process 100 may be used to generate a model 124 for predicting patients who are proper candidates to utilize a trial period of neuromodulation therapy for pain relief by having questionnaire 102 be related to pain relief, by having the sets of patients 104, 114 include those who suffer from some degree of chronic pain, and by utilizing specialist(s) who are pain relief experts. This process 100 may then be used to generate a model 124 for predicting patients who are proper candidates to utilize a trial period of neuromodulation therapy for incontinence by having the questionnaire 102 be related to incontinence, by having the sets of patients 104, 114 include those who suffer from some degree of incontinence, and by utilizing specialist(s) who are incontinence experts.

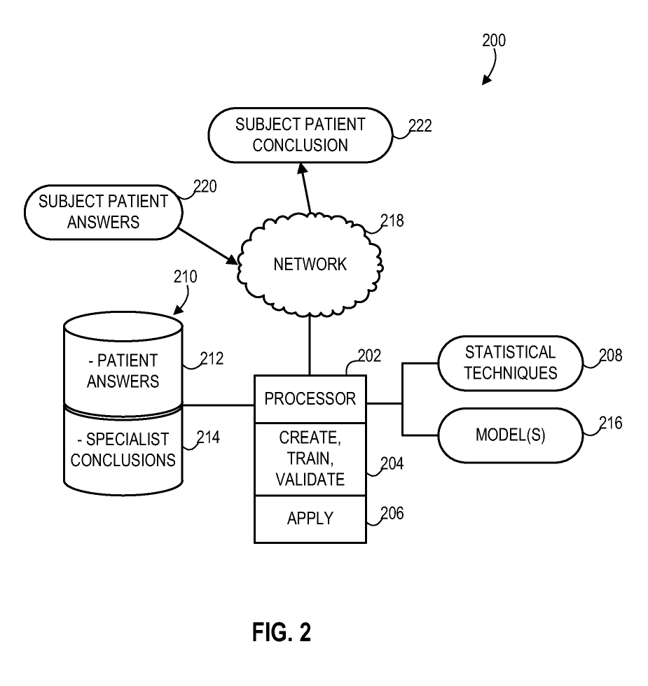

FIG. 2 shows an example of a computer system 200 that may be used to create, train, and validate the model and may also be used by primary care physicians to apply the model in practice for subject patients. The computer system 200 includes one or more processors 202 such as general purpose programmable processors, application specific processors, hardwired digital logic, and the like. The processor 202 implements model development logic 204 to create, train, and validate the model as discussed in relation to FIG. 1. The processor 202 may further implement logic to apply the model in practice 206.

The processor 202 accesses a database 210 that contains the patient answers 212 to the questionnaire. The collection of patient answers 212 may not be separated into training sets and validation sets initially. The processor 202 may use a particular scheme to build the training set and the validation set from the collection 212. For instance, the processor 202 may select all patients with odd identification numbers as the training set and all patients with even identification numbers as the validation set. Alternatively, the processor 202 may randomly select patients for training and validation.

When building a model specific to a geographical location, the processor 202 may select patients for the training set and patients for the validation set that correspond to the geographical location of interest, where the database collection 212 may contain patient answers from many geographical locations. The database 210 may already have the patients grouped by geography and the processor 202 confines the choices to the correct group, or the processor 202 may otherwise analyze each patient for the proper geography.

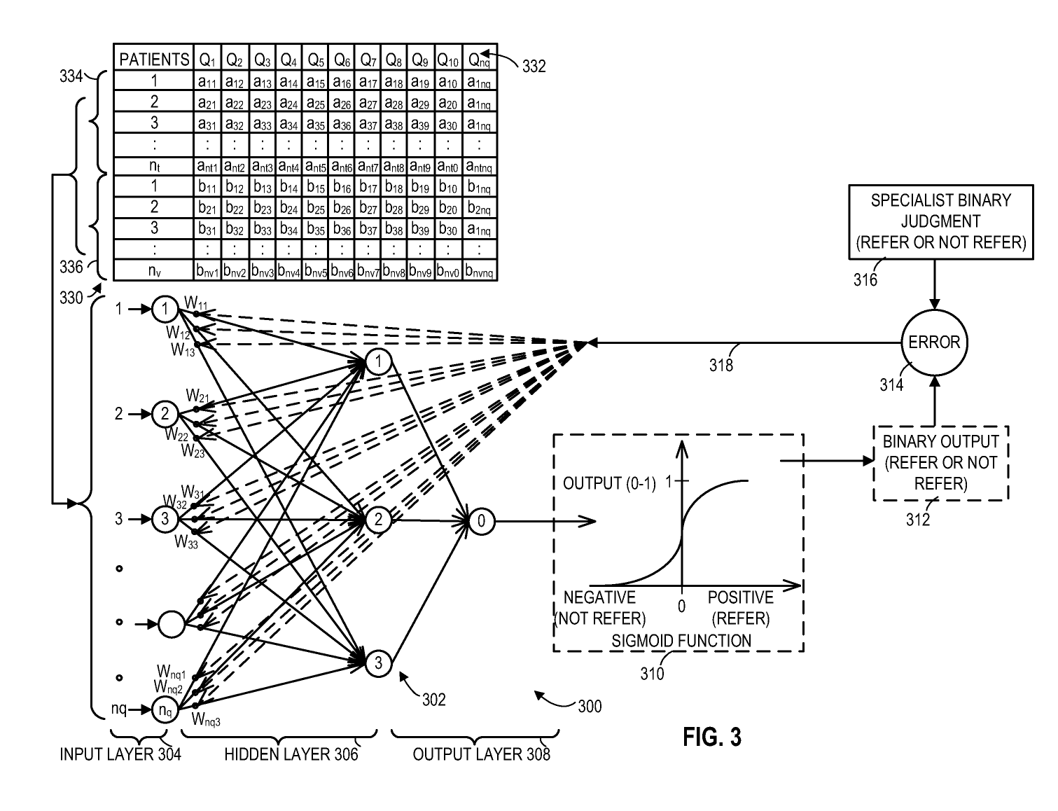

The database also contains the specialist conclusions 214 for each patient that provided the answers 212, and the processor 202 obtains those conclusions 214 for use in training or validating the model(s) 216. The processor 202 also accesses statistical techniques 208 such as the neural network modeling techniques, the logistic regression, and/or segmentation analysis when implementing the model development logic 204 to build and apply the model(s) 216. FIG. 3, which is discussed in greater detail below, provides an example where the processor 202 applies a neural network modeling technique to the patient answers and specialist conclusions.

The model creation, training, and validation itself may be a distributed process where the patient answers 212 and/or specialist conclusions 214 are received from remote locations. For instance, the processor 202 may provide a website interface through a network 218 such as the Internet. Additionally, the processor 202 may periodically update the model(s) 216 based on additional patient answers gathered over time where additional specialist conclusions 214 are sought in order to further train and validate the model(s) based on the additional patient data to ensure model adaptation to the changes over time or trending over practice in standard of care. Thus, the model(s) may continue to be refined over time.

The processor 202 may build the model(s) 216 for distribution to medical offices or other locations where patients may be screened for referral. For instance, the processor 202 may be responsive to download requests received via the network 218. The processor 202 may present a website where such downloads may be available. Alternatively, the processor 202 may provide local and/or remote access to the model(s) 216. For instance, the processor 202 may be located within a medical facility where patients may submit answers to the questionnaire directly to the processor 202 via a user interface device such as a keyboard or mouse, and the processor 202 may apply the relevant model 216 and supply the referral advice.

As an alternative, the processor 202 may provide the referral advice as a remotely accessed service by providing an interface such as a website that users may access through the network 218. In this case, the subject patient's answers 220 are submitted to the website interface of the processor 202 and the processor 202 then utilizes the application logic 206 to apply the appropriate model 216 to the answers 220 and then return a referral conclusion 222 to the user via the website interfaced to the network 218.

FIG. 3 illustrates a neural network example 300 of the statistical techniques 113, 208 as in implemented by the process 100 of FIG. 1 and the computer system 200 of FIG. 2, respectively. FIG. 3 utilizes various symbols that are defined as follows:

n_{q}—# of questions

n_{g}—# of groups of questions

nₚ—# of patients, where nₚ=nₜ+nᵥ

nₜ—# of patients for the training set

nᵥ—# of patients for the validation set

Wᵢⱼ—weighting factor between neurons i and neurons j (i=1, 2, 3 . . . n_{q}; j=1, 2, 3 . . . n_{g})

A neural network model 302 includes layers of neural nodes or neurons that are interconnected in various ways with the links being weighted. These layers include an input layer 304 that includes a node for each question. The patient answers from the database are provided to the neurons of the input layer 304. FIG. 3 shows an array 330 of the patient answers for the questions 332 for both the training set 334 and the validation set 336. During training of the model 302, the training set 334 is provided to the input layer 304. During validation of the model 302, the validation set 336 is provided to the input layer 304.

The neural network 302 also includes a hidden layer 306 of neurons with connections back to the neurons of input layer 304, and to an output neuron of an output layer 308. The output neuron of layer 308 produces an output value that falls on a sigmoid function 310. If the output falls on the negative side of the sigmoid function 310, then the model produces a binary output 312 that the patient should not be referred. If the output falls on the positive side of the sigmoid function 310, then the model produces a binary output 312 that the patient should be referred.

When training the model 302 according to the process 100 of FIG. 1, where the model 302 is driven to an ideal sensitivity and specificity, the specialist conclusion 316 for a given patient is compared to the proposed binary output 312 at an error node 314, and back propagation 318 that is based on the error is then used to alter the parameters of the neural network 302. For instance, the weighting (Wij) of one or more connections between nodes may be changed to attempt to drive the output 312 to the binary value matching that of the specialist conclusion 316.

Once the neural network 302 is weighted so that the desired ideal sensitivity and specificity are achieved for the first set of patients, the model 300 is then validated against the second set of patients by removing the back propagation 318 and keeping track of the errors at node 314 to produce the resulting sensitivity and specificity. If the resulting sensitivity and specificity of the model 300 do not achieve a target sensitivity and specificity during the validation, then training may be continued with additional sets of patient data and specialist conclusions to again drive the model 300 to the ideal sensitivity and specificity for this additional training data by using the back propagation 318. Then validation can be repeated where the back propagation 318 is removed to ultimately achieve the target sensitivity and specificity.

Once the model 300 has been validated, the model is then applied in practice to the subject patients. When applying the validated model 300 in practice, the output 312 is presumed to be accurate based on the model 300 having been validated and therefore the output 312 determines whether the subject patient is to be referred. Thus, in practice, the error node 314 and back propagation 318 are omitted and the specialist conclusion 316 may not exist and is not necessary since the model 300 is expected to achieve an acceptable result.

While embodiments have been particularly shown and described, it will be understood by those skilled in the art that various other changes in the form and details may be made therein without departing from the spirit and scope of the invention.

What is claimed is:

1. A method of creating a screening tool related to a medical therapy, comprising:
training a model that predicts whether a patient is a candidate for assessment by a specialist for the medical therapy based at least on answers patients provide to a set of questions, the model being trained by driving the model to an ideal sensitivity and ideal specificity by:
using patient answers to the set of questions from a first set of patients and
using a conclusion by at least one specialist of whether each patient of the first set is a candidate; and
validating the model in relation to a target sensitivity and target specificity that is less than the ideal sensitivity and ideal specificity by:
applying the model to at least patient answers to the set of questions from a second set of patients to produce a result for each patient of the second set,
comparing the result for each patient of the second set to a conclusion by at least one specialist of whether each patient of the second set is a candidate to produce a resulting sensitivity and a resulting specificity, and
comparing the resulting sensitivity to the target sensitivity and the resulting specificity to the target specificity.

2. The method of claim 1, wherein the model employs a neural network to produce the result from at least the patient answers to the set of questions.

3. The method of claim 2, wherein training the model comprises weighting neurons of the neural network to drive the model to the ideal sensitivity and the ideal specificity.

4. The method of claim 1, wherein the at least one specialist reaches a conclusion related to the geographical location of the at least one specialist, the method further comprising repeating the training and validation for a plurality of geographical locations and using a specialist from a corresponding geographical location to create a plurality of corresponding models unique to each geographical location.

5. The method of claim 4, wherein repeating the training and validation for the plurality of geographical locations further comprises obtaining answers to the set of questions from patients in each of the geographical locations and adding them to a same database such that some of the patients of a first geographical location are assigned to the first set of patients and some of the patients of the first geographical location are assigned to the second set of patients.

6. The method of claim 1, wherein the at least one specialist reaches a conclusion related to a modality of standard of care of the at least one specialist, the method further comprising repeating the training and validation for a plurality of specialists having different modalities of standard of care to create a plurality of corresponding models unique to each modality of standard of care.

7. The method of claim 1, wherein the answers from the first set and the second set of patients are stored in a same database, the method further comprising choosing the patients of the first set and the patients of the second set and obtaining answers of the first set and of the second set from the database accordingly.

8. A method of screening patients in relation to a medical therapy, comprising:
training a model that predicts whether a patient is a candidate for assessment by a specialist for the medical therapy based at least on answers patients provide to a set of questions, the model being trained by driving the model to an ideal sensitivity and ideal specificity by:
using patient answers to the set of questions from a first set of patients and
using a conclusion by at least one specialist of whether each patient of the first set is a candidate;
validating the model in relation to a target sensitivity and target specificity that is less than the ideal sensitivity and ideal specificity by:
applying the model to at least patient answers to the set of questions from a second set of patients to produce a result for each patient of the second set,
comparing the result for each patient of the second set to a conclusion by at least one specialist of whether each patient of the second set is a candidate to produce a resulting sensitivity and a resulting specificity, and
comparing the resulting sensitivity to the target sensitivity and the resulting specificity to the target specificity; and
prior to a subject patient being assessed by a subject specialist:
obtaining answers to the set of questions from the subject patient,
applying the model to at least the answers from the subject patient,
referring the subject patient to the subject specialist when a result of applying the model predicts that that subject patient is a candidate for assessment, and
not referring the subject patient to the subject specialist when the result of applying the model predicts that that subject patient is not a candidate for assessment.

9. The method of claim 8, wherein the model employs a neural network to produce the result from at least the patient answers to the set of questions.

10. The method of claim 9, wherein training the model comprises weighting neurons of the neural network to drive the model to the ideal sensitivity and the ideal specificity.

11. The method of claim 8, wherein the at least one specialist reaches a conclusion related to the geographical location of the at least one specialist, the method further comprising repeating the training and validation for a plurality of geographical locations and using a specialist from a corresponding geographical location to create a plurality of corresponding models unique to each geographical location, and wherein applying the model to the answers from the subject patient comprises applying the model corresponding to the geographical location of the subject patient.

12. The method of claim 11, wherein repeating the training and validation for the plurality of geographical locations further comprises obtaining answers to the set of questions from patients in each of the geographical locations and adding them to a same database such that some of the patients of a first geographical location are assigned to the first set of patients and some of the patients of the first geographical location are assigned to the second set of patients.

13. The method of claim 8, wherein the at least one specialist reaches a conclusion related to a modality of standard of care of the at least one specialist, the method further comprising repeating the training and validation for a plurality of specialists having different modalities of standard of care to create a plurality of corresponding models unique to each modality of standard of care, and wherein applying the model to the answers from the subject patient comprises applying the model corresponding to the modality of standard of care of the subject specialist.

14. The method of claim 8, wherein the answers from the first set and the second set of patients are stored in a same database, the method further comprising choosing the patients of the first set and the patients of the second set and obtaining answers of the first set and of the second set from the database accordingly.

15. A computer system for creating a screening tool related to a medical therapy, comprising:
a processor that is configured to:
train a model that predicts whether a patient is a candidate for assessment by a specialist for the medical therapy based at least on answers patients provide to a set of questions, the model being trained by driving the model to an ideal sensitivity and ideal specificity by:
using patient answers to the set of questions from a first set of patients and
using a conclusion by at least one specialist of whether each patient of the first set is a candidate; and
validate the model in relation to a target sensitivity and target specificity that is less than the ideal sensitivity and ideal specificity by:
applying the model to at least patient answers to the set of questions from a second set of patients to produce a result for each patient of the second set,
comparing the result for each patient of the second set to a conclusion by at least one specialist of whether each patient of the second set is a candidate to produce a resulting sensitivity and a resulting specificity, and comparing the resulting sensitivity to the target sensitivity and the resulting specificity to the target specificity.

16. The computer system of claim 15, wherein the model employs a neural network to produce the result from at least the patient answers to the set of questions.

17. The computer system of claim 16, wherein the processor is configured to train the model by weighting neurons of the neural network to drive the model to the ideal sensitivity and the ideal specificity.

18. The computer system of claim 15, wherein the at least one specialist reaches a conclusion related to the geographical location of the at least one specialist, the processor being further configured to repeat the training and validation for a plurality of geographical locations and use a specialist from a corresponding geographical location to create a plurality of corresponding models unique to each geographical location.

19. The computer system of claim 18, wherein the processor is configured to repeat the training and validation for the plurality of geographical locations by obtaining answers to the set of questions from patients in each of the geographical locations and adding them to a same database such that some of the patients of a first geographical location are assigned to the first set of patients and some of the patients of the first geographical location are assigned to the second set of patients.

20. The computer system of claim 15, wherein the at least one specialist reaches a conclusion related to a modality of standard of care of the at least one specialist, and wherein the processor is further configured to repeat the training and validation for a plurality of specialists having different modalities of standard of care to create a plurality of corresponding models unique to each modality of standard of care.

21. The computer system of claim 15, wherein the answers from the first set and the second set of patients are stored in a same database, and wherein the processor is further configured to choose the patients of the first set and the patients of the second set and obtain answers of the first set and of the second set from the database accordingly.
